(19) United States
(12) Patent Application Publication
(10) Pub. No.: US 2003/0043054 A1
(43) Pub. Date: Mar. 6, 2003

(54) Non-provisional patent application of martin richard wachter for automated control of electronic devices

(76) Inventor: Martin Richard Wachter, Baltimore, MD (US)

Correspondence Address: STAAS & HALSEY LLP, 700 11TH STREET, NW, SUITE 500, WASHINGTON, DC, 20001, US

(21) Appl. No.: 10/274,122

(22) Filed: Oct. 21, 2002

Related U.S. Application Data
(63) Continuation of application No. 09/002,721, filed on Jan. 5, 1998, now Pat. No. 6,469,633.
(60) Provisional application No. 60/034,014, filed on Jan. 6, 1997.

(51) Int. Cl. G08C 19/00

(52) U.S. Cl. 340/825.69

(57) ABSTRACT

A novel apparatus and method for controlling electronic devices, comprises a radio frequency (RF) transmitter and receiver for communication between the apparatus and a user, a central processing unit (CPU) executing software for handling the conversion of an RF signal from the user into a two dimensional location (an X, Y coordinate system) and conversion into a series of remote control commands for transmission to a series of devices equipped for remote control is provided by which a user can control the electronic devices of an electronic system, for example a home entertainment system (which might include, by way of example, a television, a DSS or satellite receiver, a CD player, a video recorder, a video disc player, a radio tuner, an amplifier, a tape deck, an audio video preamplifier or a combination of one or more of the foregoing). The CPU also executes software which digitizes real time video and combines it with computer graphics for display.

### RELATED APPLICATIONS

This application is a continuation-in-part of U.S. Provisional Patent Application Serial No. 60/034,014, filed Jan. 6, 1997.

### FIELD OF INVENTION

The present invention relates in general to control of electronic devices, and in particular to a new and useful control using a radio frequency (RF) remote controller which lets a user operate remote controllable devices using a central processing unit and graphical user interface software.

### BACKGROUND INFORMATION

The invention described and claimed herein comprises a novel apparatus and method for controlling remote controllable electronic devices (hereinafter, “RCED”), comprising:

a radio frequency (RF) transmitter and receiver for communication with a user,

a central processing unit (CPU) which manages radio frequency (RF) and control data, real time video input and output, and executes software for handling the user's commands transmitted from the RF transmitter, and

a control signal generator (comprising an electrical or infrared (IR) emitter for generating electrical or IR serial signals coded so as to activate desired functions of an RCED)

so as to control one or more RCEDs.

The CPU and software provide the user with graphical and textual representations of the commands or tasks that each RCED can accept, by combining computer generated graphics with real time video and displaying this combined interface to the user by means of a video display system.

Grouping one or more electronic devices (also known as “components”) has become increasingly popular and complex for the user to operate. Such groupings are variously known as “home theaters” or “home entertainment centers” in the home environment, and as “board room systems”, “presentation systems², or “sales demonstration systems” in the office or business environment—the operation of these systems is similar, and will be described below with reference to a home system, although the same principles could be applied to any grouping of remote controllable electronic components.

A home entertainment center typically comprises one or more RCEDs, examples of which include a television or video projection system, a satellite or cable TV receiver, a CD player, a video recorder, a video disc player, a radio tuner, a tape deck, amplifiers, speakers, motorized devices, lighting systems, computer systems. Each of these consumer electronic devices may be provided with a remote control or a technical specification which allows the user to operate it's functions from a distance.

However, typical state of the art systems present the following complications:

1) There is no common “language” for remote control; thus, a user with multiple components must own, (and master the operation of) multiple remote controllers.

2) The user must store, relocate and protect each of these remote controllers.

This takes storage space, and the ability to manually search for the correct remote when the user wishes to control a particular device or component. This is a problem in the home as users do not want to clutter their living rooms or home theaters with dozens of remote controls or expensive bulky touchscreens. This is a problem in the business environment as a presenter does not want to fumble around in the dark searching for a remote control during a presentation. This is a problem in the retail market as the retailer must store, locate, and protect from theft each of the remote control devices.

3) Typical remote controllers contain more buttons than a human hand has digits. The typical user becomes confused by the number of commands available all at once.

4) Typical remote controllers have a limited number of one purpose buttons; a user must memorize the function of each button (for each component). In most cases, the physical location of the button and the description of the button can not be changed.

5) Typical remote controllers store infrared command codes internally in the controller itself, and transmit these codes to the component. These transmissions are line-of-sight and therefore either preclude concealment of the component or require expensive repeater systems to receiver the line-of-sight transmission and retransmit the IR beam to the concealed location.

6) Typical remote controllers require the user to look at and refocus their attention on multiple objects as well as manipulate multiple remote controls.

The user must change visual focal point from the viewing of a video picture to locate the proper remote control device, put down the current remote control device, look at the remote control device and determine which button to press, then refocus on the video or audio component to determine if they pressed the correct button and determine if the desired change occurred.

### SUMMARY OF THE INVENTION

The foregoing problems are overcome, and other advantages are provided by a novel apparatus and method for controlling RCEDs, comprising a radio frequency (RF) transmitter and receiver for communication between the user and the apparatus, a central processing unit (CPU) which manages radio frequency (RF) and control data, real time video input and output, and executes software for handling user commands, transmitted from the RF transmitter, and a control signal generator, which control one or a series of RCEDs.

The user of the system views a video display (typically, a TV screen or monitor of the home theater, presentation system, or sales demonstration system) which has two modes of operation: Full Screen Mode and Control Mode. Full Screen Mode is a mode that displays video on the entire video display just as one might expect video to be displayed without this invention. Control Mode is similar the effect of a “heads up display” that a fighter pilot uses to fly, control, and monitor the status of his or her jet during operation, without having to look down at the controls or move their hands to other controls. Control Mode provides this functionality for the user of electronic devices.

In Control Mode, the CPU and software create a combined screen of real time video signal and computer generated graphics with graphic and textual “buttons” which represent a single command function or multiple command functions. In Full Screen Mode, the real time video signal occupies the entire screen. In Full Screen Mode, preferably the video signal path of the computer graphics is bypassed, thereby removing the added overhead and signal degradation of combining video signal with computer generated graphics.

It is an object of the invention to provide a means for controlling multiple electronic components via a single user-operated remote control device.

It is a further object of the invention to provide a means for controlling electronic devices using an on-screen graphical interface.

It is a further object of the invention to provide a means for controlling electronic devices which are located in a concealed location.

A principal feature of the invention is communication between the user and an electronic system via RF, which does not require line-of-sight. An advantage of this feature is the ability to conceal the components of the system.

Another principal feature of the invention is to allow customization of the placement and representation of the buttons which the user triggers to control electronic devices. An advantage of this feature is that each user can have the commands ordered and depicted in a familiar layout or pattern. Textual buttons can be labeled in multiple languages.

Another principal feature of the invention is to allow the user to operate the entire system using one hand. An advantage of this feature is to allow the user to use the other hand for an additional task.

Another principal feature of the invention is to allow the user to operate the entire system without looking away from the video monitor or TV. An advantage of this feature is to allow the user to concentrate and focus on the audio and video content, and not the physical location of the remote command buttons.

Another principal feature of the invention is software and hardware which permits automated training of the system, i.e., automated acquisition of the codes necessary to control the various electronic devices into a single unit. An advantage of this feature is simplicity of setup and the ability to learn the commands of new components which may exist in the future.

These and other objects, features and advantages which will be apparent from the discussion which follows are achieved, in accordance with the invention, by providing a novel apparatus and method for controlling electronic devices, comprising a radio frequency (“RF”) transmitter and receiver for communication between the user and thee apparatus, a central processing unit (CPU) which manages radio frequency (“RF”) and control data, real time video input and output, and executes software for handling user commands, transmitted from the RF transmitter, and a control signal generator, which control a series of electronics devices which are equipped for remote control.

The various features of novelty which characterize the invention are pointed out with particularity in the claims annexed to and forming a part of this disclosure. For a better understanding of the invention, its advantages and objects, reference is made to the accompanying drawings and descriptive matter in which a preferred embodiment of the invention is illustrated.

### BRIEF DESCRIPTION OF THE DRAWINGS

The foregoing and still other objects of this invention will become apparent, along with various advantages and features of novelty residing in the present embodiments, from study of the following drawings, in which:

FIG. 1 is a schematic diagram of the components of an embodiment of the invention.

FIG. 2 is a flow chart of the basic steps of operating an embodiment of the invention.

FIG. 3 is an illustration of a prior art controller suitable for use with the invention.

FIG. 4 is a schematic diagram of a typical configuration of the control and connections to enable infrared remote control and serial remote control of components.

FIGS. 5-9 illustrate sample GUI screen displays.

FIG. 10 is a flow chart of software suitable for controlling a cpu to implement the invention.

### DESCRIPTION OF THE PREFERRED EMBODIMENT

The invention is a novel apparatus and method for controlling electronic devices, comprising a radio frequency (“RF”) transmitter and receiver for communication between the user and the apparatus, a central processing unit (CPU) which manages RF and control data, real time video input and output, and executes software for handling user commands, transmitted from the RF transmitter, and a control signal generator, which control a series of electronics devices which are equipped for remote control.

The novel apparatus and method for controlling remote controllable electronic devices (“RCEDs”), comprises an RF transmitter/receiver [1], a central processing unit (CPU) [2] executing software for handling the conversion of an RF signal from the user into a two dimensional location (an X, Y coordinate system) and conversion into a series of remote control commands for transmission to one or a series of control signal generators, for example an infrared transceiver [7] for controlling one or a series of RCEDs [3], enabling a user to control the RCEDs [3], by way of example, those found in a home entertainment system (including, by way of further example, a television, a DSS or satellite receiver, a CD player, a video recorder, a video disc player, a radio tuner, an amplifier, a tape deck, an audio video preamplifier or a combination of one or more of the foregoing).

The principles may be applied to a wide variety of electronic component configurations, but can be illustrated with respect to a sample configuration of a home theater system which has been constructed as a prototype.

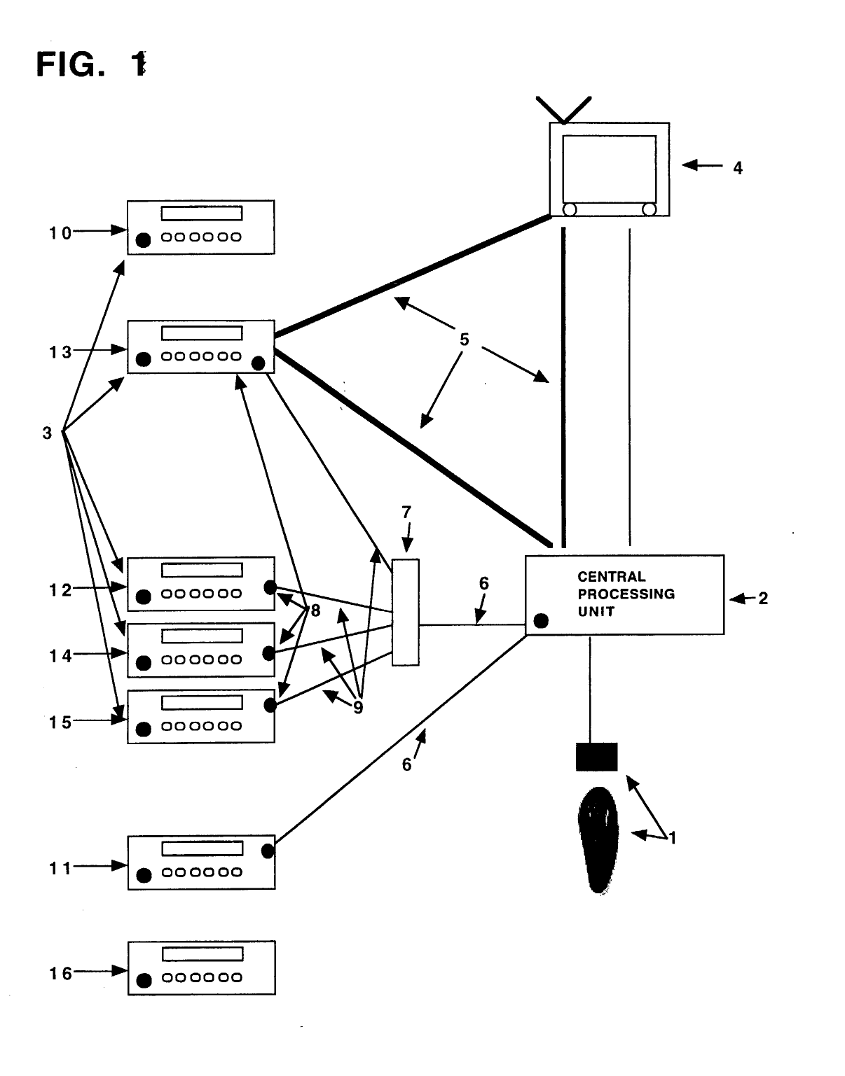

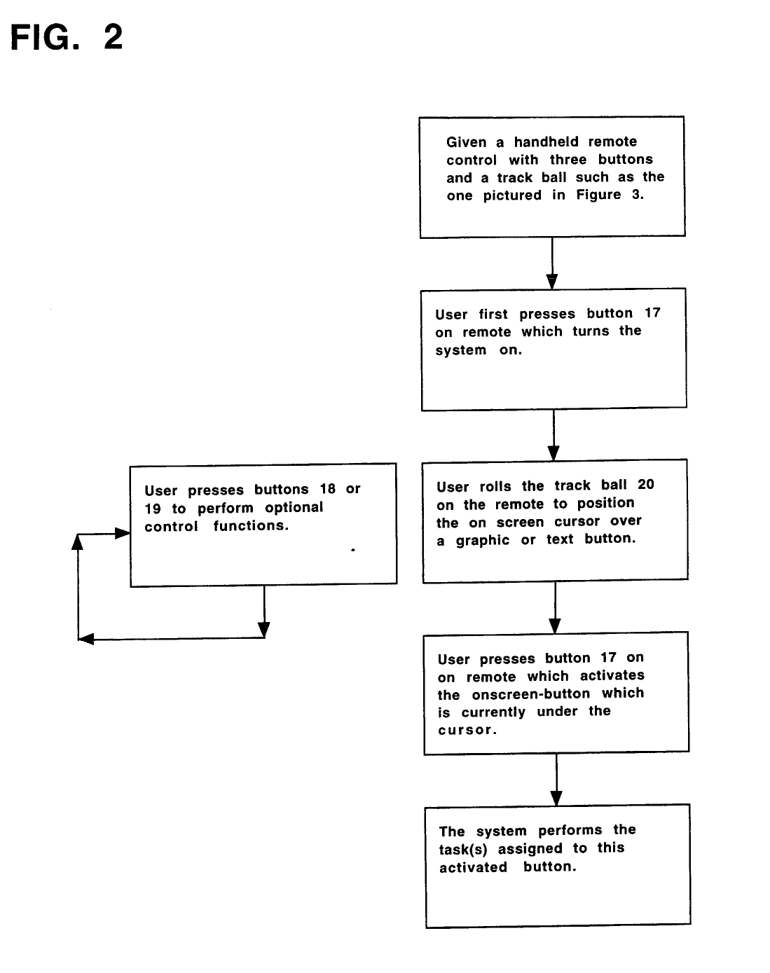

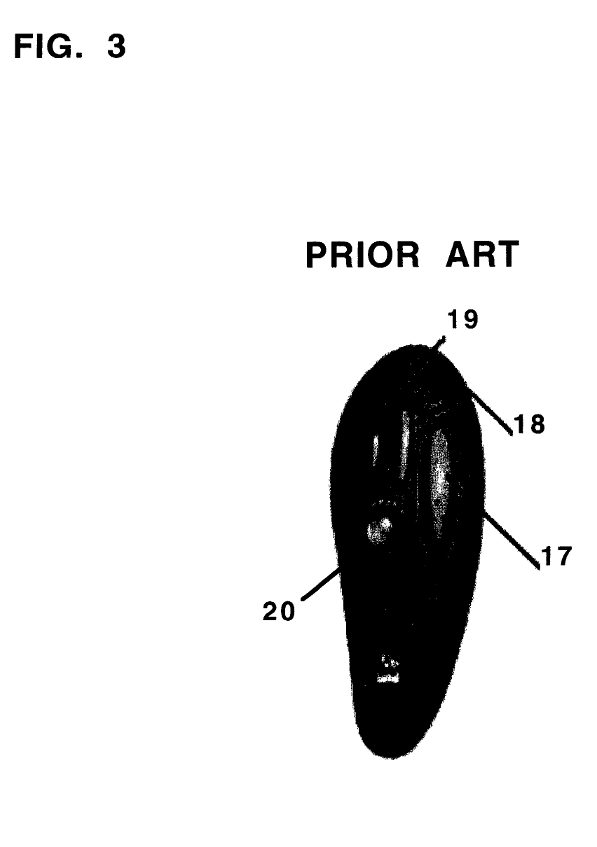

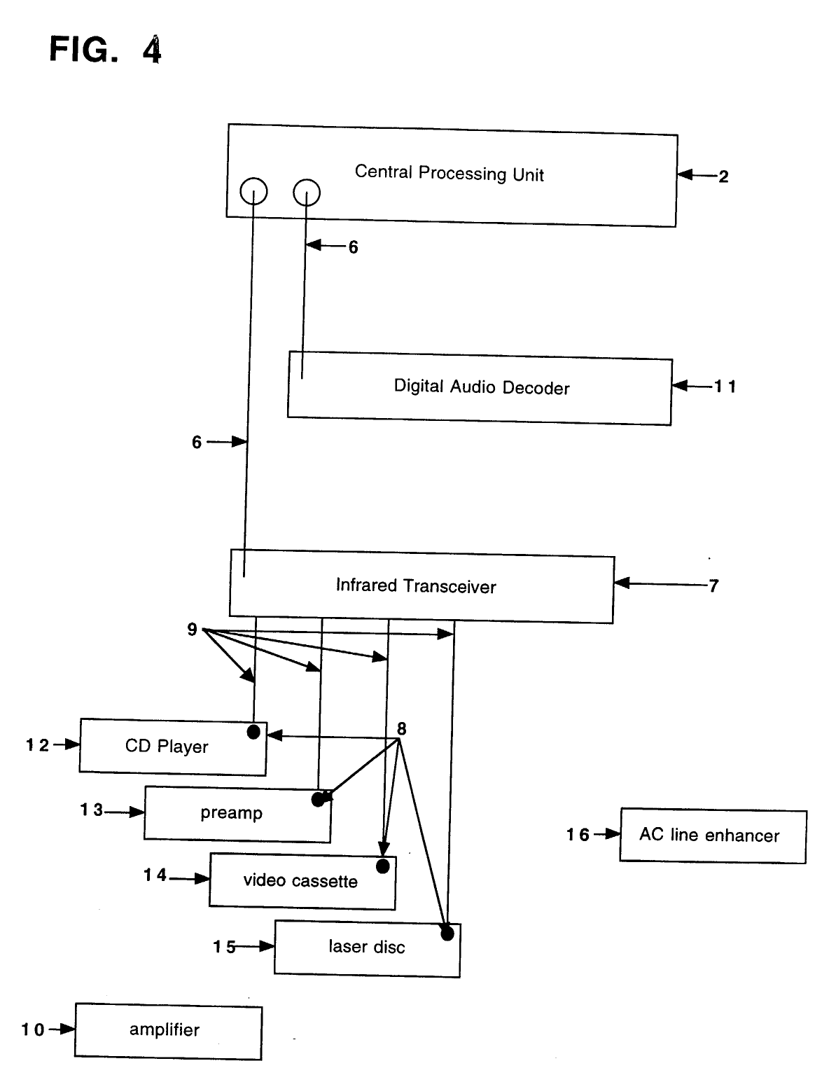

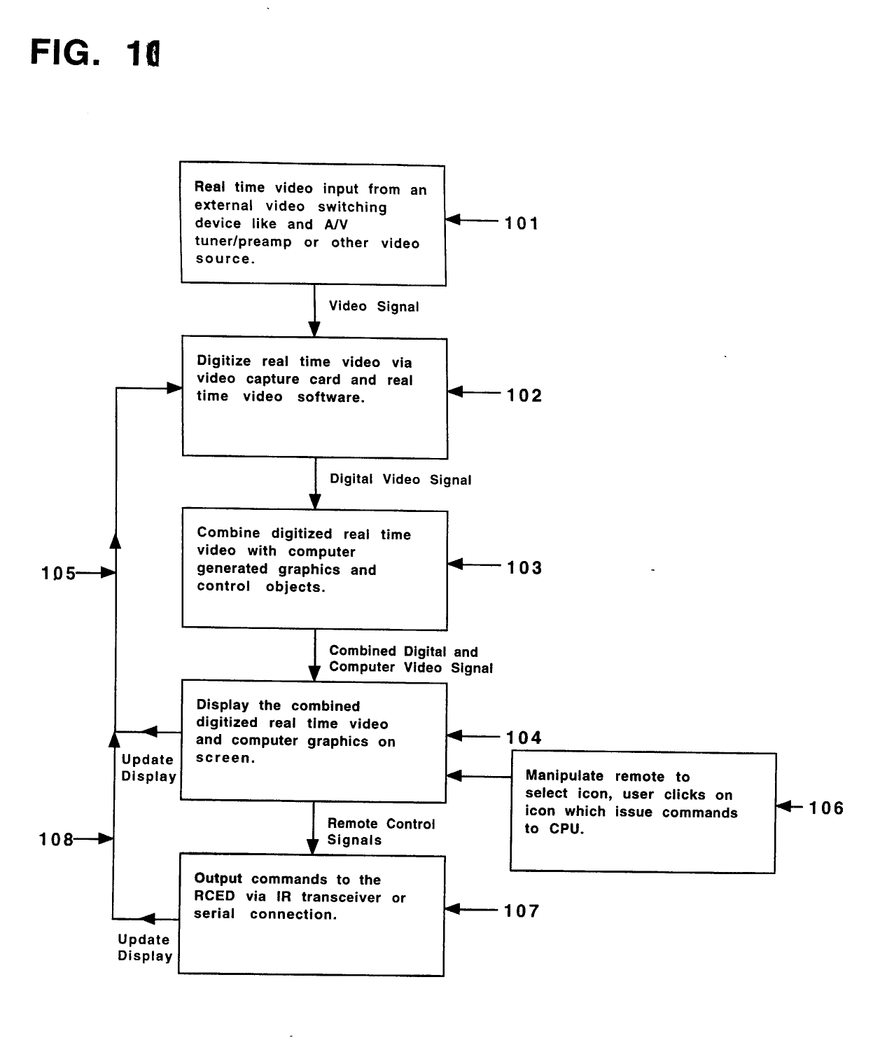

Referring to the drawings, the invention as shown in overview in FIG. 1 comprises an RF transmitter/receiver [1] for communication between the user and a central processing unit (CPU) [2] executing software [a flow chart of which is shown in FIG. 10] which manages radio frequency (“RF”) and control data, real time video input and output communicated over video cable [5], and handles user commands, transmitted from the RF transmitter/receiver [1], to activate a control signal generator [7], which control a series of RCEDs [3] and was implemented in the prototype using a monitor [4] of a home theater system, under software control to offer two on-screen display modes which are selectable by the user: Full Screen Mode, and Control Mode.

The prototype consisted of the components illustrated in FIG. 1, i.e.:

RF Transmitter/Receiver [1] was a Logitech TrackMan (R) Live! (TM) ADB cordless mouse RF transmitter (Model No. B3P/N−804125−00=B2 was used in the prototype) and Logitech TrackMan (R) Live! (TM) RF receiver (Model No. 10 B3P/N−811339−0000 was used in the prototype)

Said RF transmitter/receiver [1] was coupled to CPU [2] which was a MACINTOSH (R) CPU, preferably at least a 660 av with 8 megabytes of RAM and 80 megabyte hard drive via a mouse port (although any CPU with adequate processing speed for realtime video I/O, and ample RAM and hard disc space for the operating system, the control software and their associated files would be satisfactory).

Said CPU [2] also requires support components according to the particular implementation, all of which could be selected by one of ordinary skill in the art. A PowerMac(TM) 7200/75, available from Apple Computer, with an XCLAIM (TM) VR 2 megabyte video card, available from ATI, would be satisfactory.

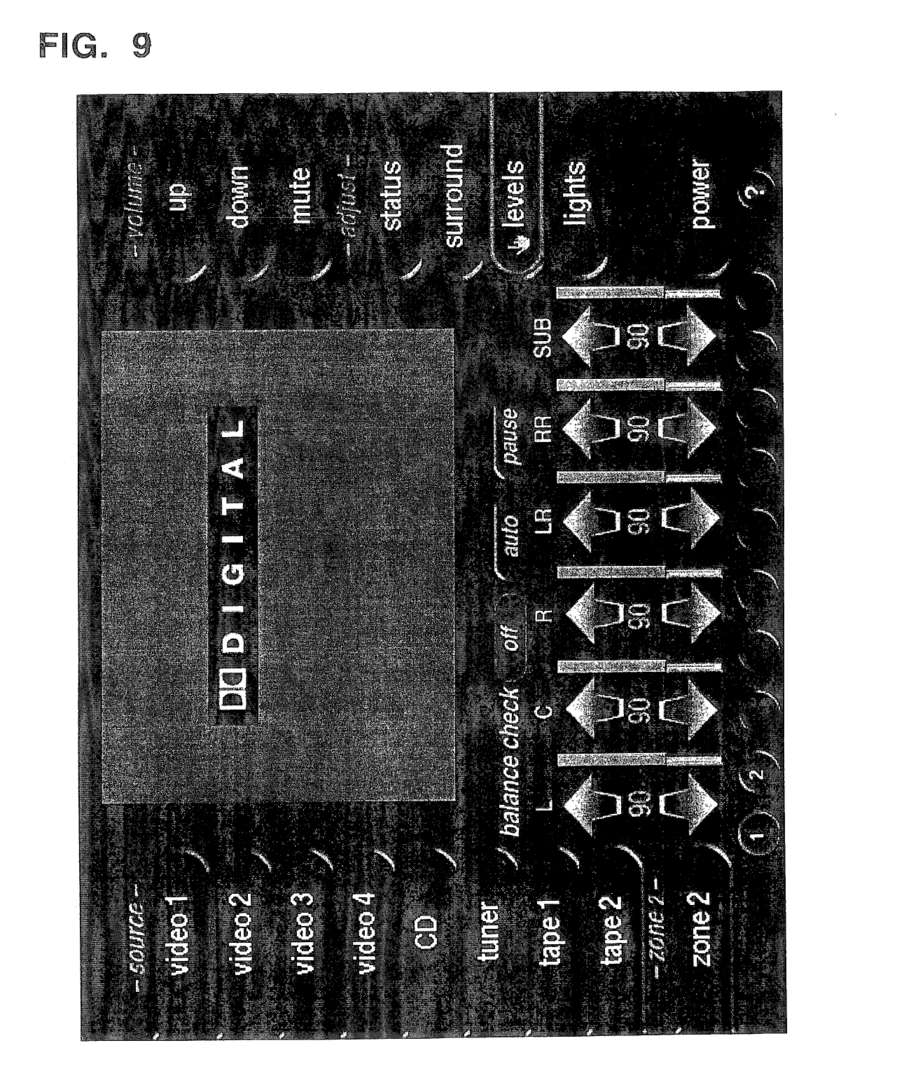

Said CPU [2] must execute software capable of implementing the instructions set forth in the flow chart of FIG. 9; a suitable program written in C++ compiled using a Metrowerks CodeWarrior (TM) C++ compiler is embodied as source and executable code as a self-extracting compressed file on the Macintosh formatted disk attached to this application.

Said CPU [2] was coupled via serial cable [6] connected between the serial port of the CPU [2] and the input of an IR transceiver [7].

Said IR transceiver [7] had, in the prototype, 4 dual IR emitters, but in general must be capable of controlling a suitable number of ir emitters [8] selected according to the design of the overall system, and coupled to RCEDs via IR cable [9].

Home Theater Components of the user's selection, each having an IR or serial control; the prototype consisted of the following components:

amplifier [10]; in the prototype, Adcom GFA-7000 THX 5 channel power amp

Controller signal generator [7] (in the prototype, comprising Macintosh 7200 CPU with ATI video I/O card, JDS IRXP2 transceiver, JDS Power sensor input connecting block, Smartlinc power sensors, Xantech IR emitters, and Logitech Trackman Live for Macintosh)

Digital decoder [11] (in the prototype, Adcom BOS-510 Dolby (R) digital decoder)

CD player [12] (in the prototype, Adcom GCD-700 five disc CD player)

Tuner-preamp [13] (in the prototype, Adcom GTP-600 tuner preamp A/V switcher, Dolby (R) Pro Logic (R) decoder)

Video cassette deck [14] (in the prototype, Yamaha YV-700 video cassette deck]

Laser disc player [15] (in the prototype, Marantz Multi Laser disc player LV 520 RCA DSS model DS7430RA)

AC line switcher/enhancer [16] (in the prototype, Adcom ACE-515 AC Line switcher and enhancer)

Monitor [4] (in the prototype, Sharp H37U LCD video projector and Draper PermaWall 100 screen)

With the prototype so constructed, operation is as follows:

The CPU executed suitable software, such as that summarized in the flow chart in FIG. 10, one suitable embodiment of which is provided on disc as an attachment to this application. Said software generates a graphical user interface which is displayed on the monitor [4] and can be operated using an RF mouse as RF transmitter/receiver [1]. The user interface comprises two modes: Full Screen Mode and Control Mode. In Full Screen Mode, the software displays a video signal which occupies the entire screen. (In Full Screen Mode, preferably the video signal path of the computer graphics is bypasses, thereby removing the added overhead and signal degradation of combining video signal with computer generated graphics.)

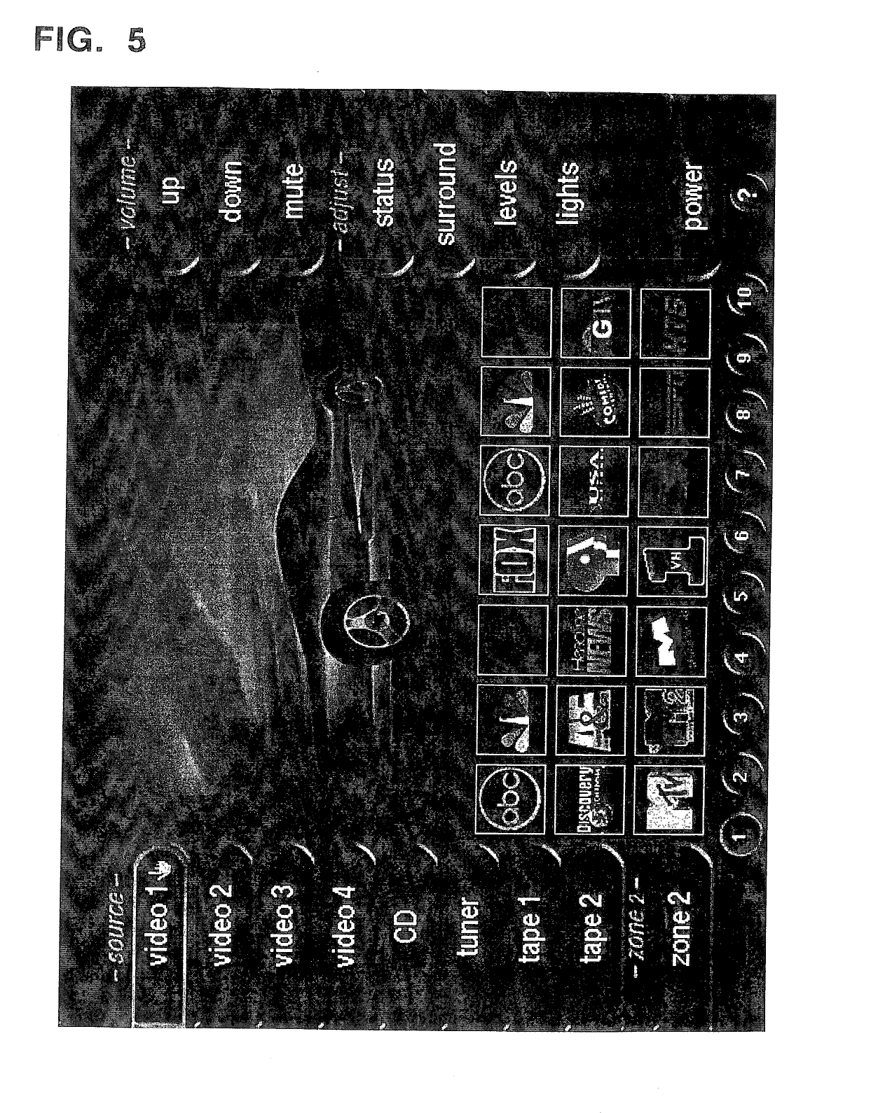

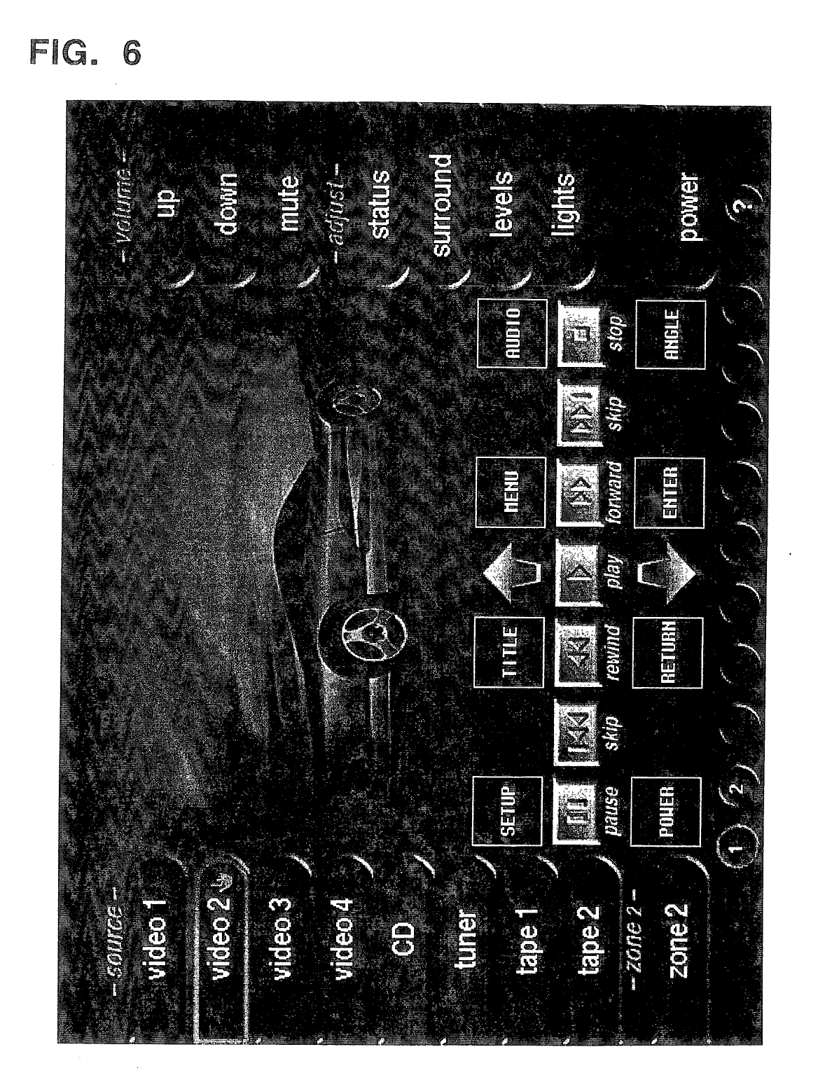

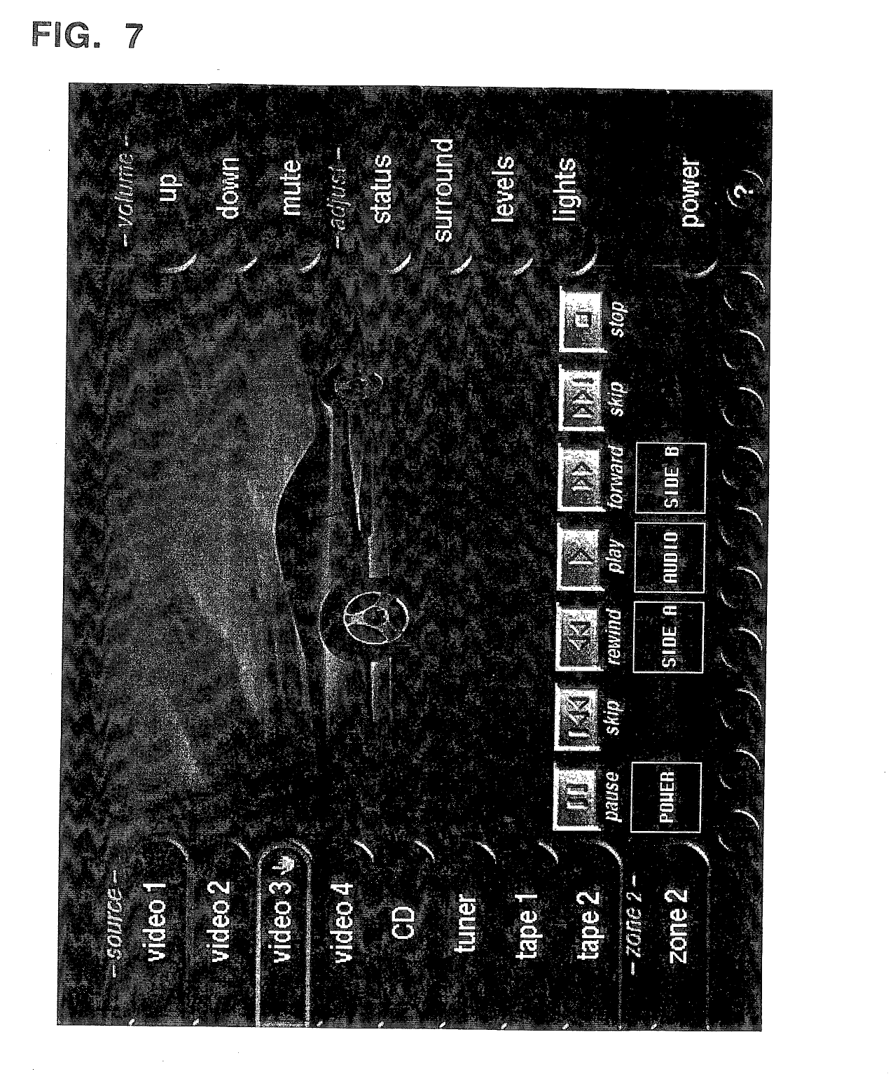

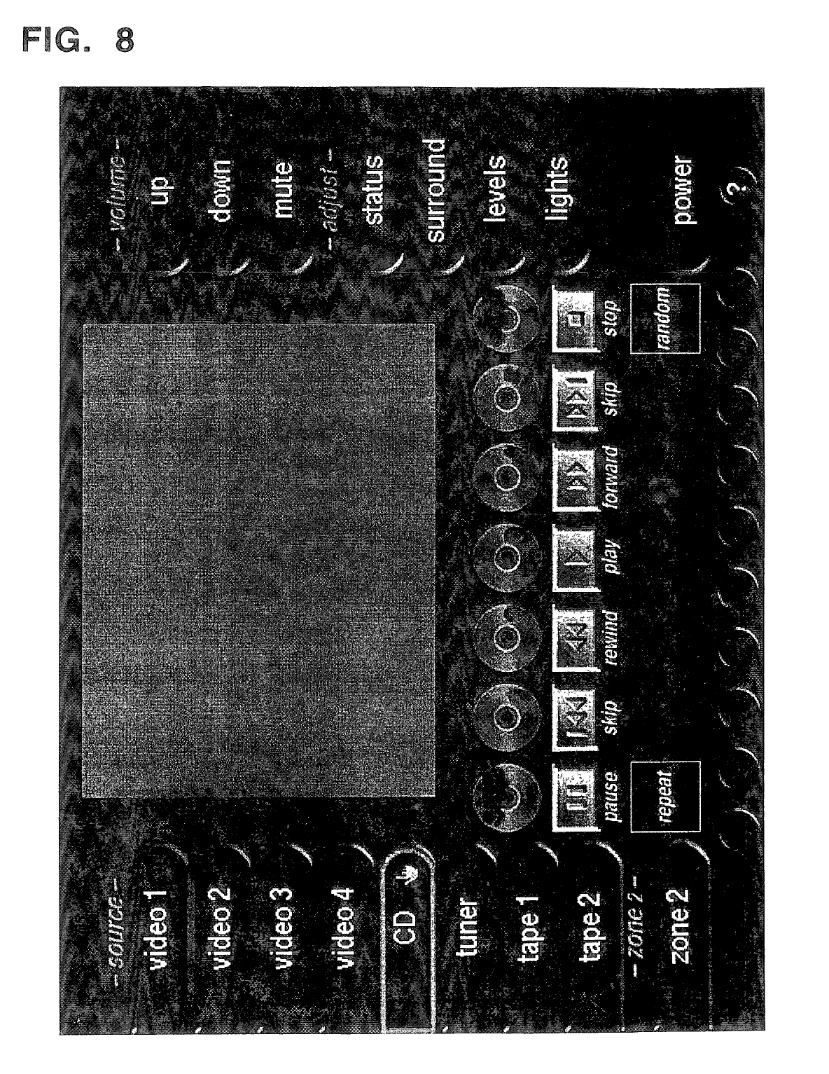

Starting in Control Mode, a real time video input is provided [101] and digitized [102], and combined with other video such as computer generated graphics or icons [103] generated by CPU [2] and displayed [104] on monitor [4]. FIGS. 5-9 illustrate samples of suitable GUI displays created by the software. The user selects which task to perform by looking at the monitor [4] and manipulating a single remote control in one hand. By utilizing simple hand-eye coordination, the user manipulates an on screen cursor over a graphical icon or text button, and CPU [2] continuously updates display on monitor [4] [step 105] until user clicks the remote which triggers the command or commands programmed into the selected icon or text button [106].

It should be noted that since the CPU [2] responds to user commands according to the location of a cursor, each button may be custom located for each user, so as to provide visual cues as to the function to be selected, thereby eliminating the need to memorize the location of the function for each different source component. For example, buttons that represents the PLAY function for three different components such as a CD player, a tape player, and a video disc player can all be located at the same location on the screen such as the center. This allows the user to become familiar with the placement of the button that issues a PLAY command regardless of the currently selected source component. In this example, the PLAY button is always in the center.

In step [107], CPU interprets the user's selection by reference to the two dimensional position (X,Y coordinate system) of the on-screen cursor, and the on screen button located at this coordinate will be executed by generating a control signal to the appropriate RCED or RCEDs via the appropriate control cable. RCEDs typically require infrared control or serial control. In the case of infrared controlled devices, the infrared code is sent from the CPU [2] to the device via IR cable [9] which has an infrared emittter [8] such as a light emitting diode (LED) or direct infrared injector plug on the terminating end, depending on the manufacturer's hardware configuration of the device. The device responds to the issued command just as if it were sent from its own infrared remote controller. In the case of serial control, a control signal is sent from the CPU to the device via a control cable connection [6]. The exact commands that are sent are dependent upon the manufacturers definition of the “language” or commands that the device accepts. These commands are typically made up of ASCII text commands and are sent via industry standard RS-232 or similar two way serial control specifications via one of the CPU's serial ports. Serial control can be one or two way. Two way communication is preferable as the system can make intelligent decisions based upon the state or status of a device or component. The display on monitor [4] is then updated [108], thereby providing visual feedback to the user.

Multiple or single commands can be setup to control the internal aspects of the hardware and/or software system, and/or perform remote control of any or all of the system components.

Since the Control Mode is not visible to the user at this time, frequently used commands are available to the user via a few buttons [18 and 19] on the same remote control. This allows important and frequent commands such as but not limited to adjusting the volume level up or down, to be issued while in Full Screen mode.

The user returns to Control Mode by clicking the same button [17] that they clicked to enter Full Screen mode.

Further details of the specification of the components and the methods of their setup, connection and operation, may be found in the following manuals which are attached to the IDS filed herewith and are included herein by reference:

Logitech Mouse and Trackball for Macintosh and Compatibles User's Guide.

ADCOM 1996 Product Specifications

ADCOM GTP-600 Surround Sound Tuner/Preamp Owner's Manual

ADCOM GCD-700 CD Player Owner's Manual

ADCOM GFB-800 Operating Instructions

JDS Infrared Xpander User Manual

SHARP XV-H37U LCD Video Projector spec sheet

Thus there has been described a novel apparatus and method for controlling electronic devices comprising a radio frequency transmitter and receiver for communication between the user and the apparatus, a central processing unit (CPU) which manages radio frequency and control data, real time video input and output, and executes software for handling user commands, transmitted from the RF transmitter, which control a series of electronic devices which are equipped for remote control, and a control signal generator, that has a number of novel features, and a manner of making and using the invention.

The foregoing prototype illustrates the construction and use of the invention, but the system and methodology of the invention are adaptable to a wide range of component configurations. Other devices which have any form of remote control can be similarly controlled, as for example X-10 power line devices and security systems, telephony systems, lighting controllers, motorized electronic devices such as window coverings, speakers, and projection screens, or electronic relay systems.

While a specific embodiment of the invention has been shown and described in detail to illustrate the application of the principles of the invention, it will be understood that the invention may be embodied otherwise without departing from such principles as that various modifications, alternate constructions, and equivalents will occur to those skilled in the art given the benefit of this disclosure. Thus, the invention is not limited to the specific embodiment described herein, but is defined by the appended claims.

I claim:

1. An apparatus for controlling an electronic device having at least one remotely controllable component (“RCC”) controllable by a remote control in response to a control signal, comprising:
a video display capable of displaying real time video and a graphical user interface comprising pictures and text corresponding to functions of said component or components;
a radio frequency (RF) signal transmitter capable of generating a number of signals, the particular signal to be generated at any given time being under control of a user and corresponding to a desired function selected by said user from among said pictures and text;
a radio frequency (RF) remote receiver for receiving RF signal transmitter signals and communicating the information content of said signals to a central processing unit;
said central processing unit executing software for converting said signals corresponding to the picture or text selected by said user into code which corresponds to an equivalent remote control signal for controlling a function or series of functions for said RCC;
transmission means for transmitting said equivalent remote control signal;
whereby said user may control the function of the RCC.

2) An apparatus as in claim 1 further comprising software for controlling the automated learning and storage system of data necessary to construct the control signals which correspond to each function.

3. An apparatus as in claim 1 wherein said electronic system comprises consumer electronic devices.

4. An apparatus as in claim 1 wherein said electronic system is a home entertainment system.

5. An apparatus as in claim 1 wherein said electronic system is a home theater system.

6. An apparatus as in claim 1 wherein said electronic system is a home entertainment system.

7. An apparatus as in claim 1 wherein said electronic system is a board room system.

8. An apparatus as in claim 1 wherein said electronic system is a presentation system.

9. An apparatus as in claim 1 wherein said electronic system is a sales demonstration system.

10. An apparatus as in claim 1 wherein said RF signal transmitter is an RF mouse.

11. An apparatus as in claim 1, further comprising means for digitizing real time video and combining said real time video with computer graphics for display.
